(19) United States
(12) Patent Application Publication
(10) Pub. No.: US 2005/0031110 A1
(43) Pub. Date: Feb. 10, 2005

(54) System and method of an improved conference call service feature in a telecommunications network

(76) Inventors: Ofer Haimovich, Tel Aviv (IL); Ofer Pizov, Tel Aviv (IL)

Correspondence Address: JASON A. BERNSTEIN;POWELL, GOLDSTEIN, FRAZER & MURPHY LLP, 16TH FLOOR, 191 PEACHTREE STREET, NE, ATLANTA, GA, 30303-1736, US

(21) Appl. No.: 10/935,512

(22) Filed: Sep. 7, 2004

Related U.S. Application Data
(63) Continuation of application No. PCT/IL02/00173, filed on Mar. 5, 2002.

(51) Int. Cl. H04M 3/42

(52) U.S. Cl. 379/202.01

(57) ABSTRACT

A system and method for an enhanced and improved conference call service is disclosed. A plurality of communication stations connected to a communications network is provided with conference call line functionality by requests. Consequently the communication stations are operative in setting up conference calls, defining conference call parameters, and participating in conference calls. The conference calls are accessible by a pre-defined sub-set of a plurality of communication stations across the network. When a first station dials a second station having conference call functionality the system provides a selection of options concerning the mode of the dialed call for the first station.

### PRIORITY CLAIM

This application is a continuation of PCT Patent Application PCT/IL02/00173 filed Mar. 5, 2002, entitled “System And Method Of An Improved Conference Call Service Feature In A Telecommunications Network”, the entirety of which is hereby incorporated herein by reference.

### BACKGROUND OF THE INVENTION

1. Field of the Invention

The present invention relates to service features provided by telecommunications networks. More specifically the present invention relates to an enhanced and improved conference call service provided by a telecommunication network to subscribers desiring to host and/or participate in a multiple call that is established among two or more communicating stations in such a manner that each of the stations is able to communicate with all the other stations.

2. Discussion of the Related Art

Many telecommunications carriers provide value-added services to their subscribers, such as call waiting, text messaging, “follow-me” service, voice mail, call identification, incoming call blocking, and the like. Conference call service is an extremely important value-added service feature that is increasingly utilized by the business community. The conference call service feature provides a multiple call feature via which several callers (typically three or more) may participate in the same call. In order to establish a conference call, a host (usually an individual having a senior position in an organization, such as an executive), typically arranges with a telecommunications carrier capable of providing the said service to reserve a number of communication ports associated with a particular communications device typically referred to as a telecommunications bridge. The bridge is a device implemented within the carrier's network designed to bridge or combine a plurality of telephone calls. The reservation process includes manual and voice interaction between an initiating conference call host and a specific human operator of the telecommunications carrier. According to the requests and the instructions of the host, the human operator manipulates a conference call support system in order to perform the necessary steps operative in the reservation of the required number of ports on a particular bridge. Alternatively, the host may reserve the requisite number of bridge ports by interacting with a substantially automated reservation system typically equipped with an Interactive Voice Response (IVR) interface. Subsequent to the reservation of the requisite number of ports on the bridge by the host, the host may schedule a conference call, and may enter the conference call with the other participants by directly dialing a specific telephone number associated with the bridge for connection to a bridge port. When the bridge receives the call, the caller's identity is examined, verified, and authenticated. The bridge recognizes the caller typically by prompting the caller to enter a pre-defined access code. Subsequently to the receipt of the proper access code for the particular conference, the bridge connects the caller with the other participants who have already joined the conference call.

Thus, in or order to join a conference call, each participant must know both the telephone number of the bridge and the requisite access code. In addition, the host must enter a separate access code which is different from the other participants' access code in order to being allowed the option to control various functional parameters operative in the desired performance of the conference call. Consequently, before a scheduled conference call, the host must communicate the bridge number and the access code to each participant eligible to enter the conference call. When the number of the scheduled participants is large, to make sure that each participant receives the correct conference bridge number and the correct conference call access code can be a substantially cumbersome operation, particularly when the group of the participants is spread out across geographically different locations. The problem of notifying all the potential conference participants of the conference bridge number and of the conference access code becomes even more obvious for frequently held routine conference calls occurring customarily at predefined constant time intervals, such as every week or every day. For each one of such a routine conference calls the host must connect to the operator of the telecommunications carrier, or to an automatic conference call reservation system in order to determine the functional parameters of the conference, to receive from the operator the assigned bridge number and the assigned access code, and then to communicate the assigned numbers suitably (via e-mail, phone, office memo, or the like) to each of the scheduled participants. It would be easily perceived by one with ordinary skill in the art that the entire procedure is cumbersome, complex, time-consuming, expensive, and potentially error-prone.

To lessen the difficulties inherent the above-described method, some telecommunications carriers allow the host to reserve the same conference bridge and enable the participants to use an identical reserved participant code for a pre-defined set of scheduled conference calls. However, for reasons of security, not all of the carriers providing this option allow every conference call host to reserve the same bridge and the same access code for every conference call.

To ease the need to communicate the bridge number to every scheduled participant, some telecommunications carriers that provide a conference call service undertake to automatically launch a call to each scheduled participant at the start of the conference call. This technique is acceptable and efficient only for those participants whose locations, and telephone numbers are known in advance of the conference call. In practice, telecommunications carriers that provide this type of service may not know the location and the telephone number of every intended participant at the beginning of the conference call. For example, one or more invited participants may be traveling, while available to participate in a conference call by utilizing a non-regular phone number, such as a company branch phone, a personal cellular phone, or even a pay phone. Furthermore, while launching a call to each participant obviates the need for the participant to know the bridge number, the participant must still receive the requisite access number for authentication in order to join the conference call.

Thus, there is a need for an improved conference call service that allows telephone subscribers to participate in a conference call from any location without the need of being notified in advance of a scheduled conference call of the particular bridge number and access number associated with the conference call.

### SUMMARY OF THE PRESENT INVENTION

One aspect of the present invention regards an electronic conference call system. The system includes a plurality of communication stations operated by a plurality of subscribers for participating in at least one conference call provided by a conference call service in such a manner that each of the plurality of communication stations is able to communicate with a sub-set of the plurality of communication stations participating in at least one conference call, at least one communication station having the functionality of conference call line operated by at least one subscriber having the capability of a conference call host in order to enable the setting up, establishment, performance, and management of at least one conference call associated with the at least one communication station to enable participation of a plurality of conference call service subscribers in the at least one conference call, at least one communication network having network equipment for interconnecting the plurality of communication stations, to a conference call service, a conference call service consisting of: a subscriber database to store the operational information related to at least one conference call, the functional definition of a plurality of communication stations serving a plurality of conference call service subscribers, and the functional definitions of the at least one communication station with the functionality of the conference call line operated by the at least one conference call host, a conference call server for the providing at least one communication station with conference call line functionality and providing at least one subscriber of at the least one communication station with conference call host capability, to enable the setting up, establishment, management, and performance of the conference call. The conference call server includes the a database component to handle subscriber information, conference host information, communication stations information, and conference call information, a connection component to connect at least one subscriber desirous of participating in a conference call to the conference call line, a disconnection component to disconnect at least one subscriber desirous of withdrawing from the conference call from the conference call line, and a network interface component to enable proper communication between the conference call service and the communications network. When a communication station requests the functionality of conference call line the conference call service provides conference call line status to the requesting station, when the station with conference call line status issues requests for the setting up, establishment and management of a conference call the conference call service responds to the requests, when requests are introduced from a plurality of a communication stations to participate in the established conference call, the conference call service connect the stations to the conference call line whereby each and every communication station connected to the communications network is enabled to operate optionally as a conference call line, and the subscribers associated with the communication stations are allowed to operate as conference call hosts.

A second aspect of the present invention regards an electronic conference call method. The method consists of the following steps: accepting the request of a subscriber associated with a communication station concerning the setting up of the communication station of as a conference call line, assigning a conference call-specific data structure to the requesting communication station and establishing the conference call-specific data structure, maintaining conference call-specific parameters in the conference call data in accordance with the requests introduced by the subscriber of the communication station associated with the conference call data structure, receiving requests of a plurality of subscribers associated with a plurality of communication stations concerning the participation thereof in the conference call associated with a conference call data structure, connecting to the conference call line subscribers participating in a conference call associated with a conference call data structure; and disconnecting from the conference line subscribers desirous of withdrawing from a conference call associated with a conference call data structure.

### BRIEF DESCRIPTION OF THE DRAWINGS

The present invention will be understood and appreciated more fully from the following detailed description taken in conjunction with the drawings in which:

FIG. 1 is a schematic block diagram of an exemplary telecommunications network in which a preferred embodiment of the present invention could operate;

FIG. 2 is a schematic block diagram illustrating an exemplary procedure operative in the registration of a subscriber for the conference call service, for the reservation of a conference call via a conference call box by the host, and for the entering of the host to a previously reserved conference call, in accordance with a preferred embodiment of the present invention;

FIG. 3 is a schematic block diagram showing a set of exemplary options associated with a menu, which is presented to an initiating host to enable maintenance of the conference call box, in accordance with a preferred embodiment of the present invention;

FIG. 4 is schematic block diagram showing the structure of an exemplary control record representing a conference call box in the subscribers' database, in accordance with a preferred embodiment of the present invention;

FIGS. 5 and 6 are simplified flow charts that describe the exemplary steps performed following an incoming call to a telephone number associated with the conference call service, in accordance with a preferred embodiment of the present invention; and

FIG. 7 is a simplified flow chart describing the steps involved in the maintenance of the conference call box by a host, in accordance with a preferred embodiment of the present invention.

### DETAILED DESCRIPTION OF THE PREFERRED EMBODIMENT

An improved and enhanced conference call service in a telecommunications network is disclosed. The present invention overcomes the disadvantages of the prior art by providing a method and system for the setting up and the establishment of a conference call by utilizing a regular directory number typically associated with a subscriber who is permanently or temporarily is functioning as the host of the conference call. Thus, the method and system makes available the option of providing specific conference call line capabilities to a communication station and thereby providing conference call host capabilities to a subscriber associated with the communication station.

A telecommunications carrier, having the capability of providing a conference call service, links the regular telephone number or a specifically assigned telephone number of a subscriber utilizing a communication station (i.e., a telephone instrument), and who is desirous of the conference call service, to a subscriber-specific conference call box. The conference call box is a data structure implemented in a conference call database within the telecommunications carrier's network designed to store operational information functional in the setting up and the establishment of a conference call. Dialing the regular telephone number or dialing a specifically coded dialing sequence will affect the performance of a pre-defined procedure comprising a variable sequence of functional steps by the network before the network could establish a functional connection. The functional sequence of steps is performed in order to offer the caller a selection of an option out of several pre-defined options associated with the telephone number representing the called communications station. The network sequence is implemented by the utilization of a set of specifically developed software programs, supported by an Interactive Voice Response (IVR) interface, by suitable data structures, and by appropriate Application Specific Integrated Circuits (ASICs). The caller could select one of the options offered by manipulating the suitable keys installed in the keypad of the call-originating communication station and thereby generating suitable pre-defined Dual Tone Multiple Frequency (DTMF) tones. The caller is given the capability of a) engaging in a regular voice conversation with the subscriber associated with the called number, b) leaving a voice message in voice message box of the subscriber associated with the called telephone number, c) entering the conference call box in order to maintain the functional conference call related parameters stored in the conference call box, and d) enter a pre-defined conference call as a eligible participant of the conference call. The communications network will make suitable connections via appropriate switching devices between the caller's communications station and, a) the called communication station, or b) the conference call box, or c) a specific conference bridge port, in accordance with the DTMF tones originated by the caller's responses, in accordance with a set of parameters defined within the conference call box, and in accordance with the coded dialing sequence via which the call was performed. By connecting the telephone number associated with the subscriber's communication station with the conference call box the network provides a substantially simplified procedure regarding the setting up of a conference call (i.e., reserving the required number of communications ports in a conference bridge at a particular point in time for a particular duration). In addition, as the establishment of a conference call is done via the regular telephone number of the subscriber the necessity of notifying scheduled participants of the scheduled conference call regarding the conference bridge number is made redundant. Optionally, the use of an access code could be made redundant as well in accordance with the requirements and instructions of the subscriber and/or the internal procedures of a related organization. As a result, the operating procedures associated with the definition, activation, and performance of a conference call will be substantially simpler, easier to execute, and less error-prone. The advantages of the proposed system and method of the present invention will affect significant savings in time, expenses, and organizational effort.

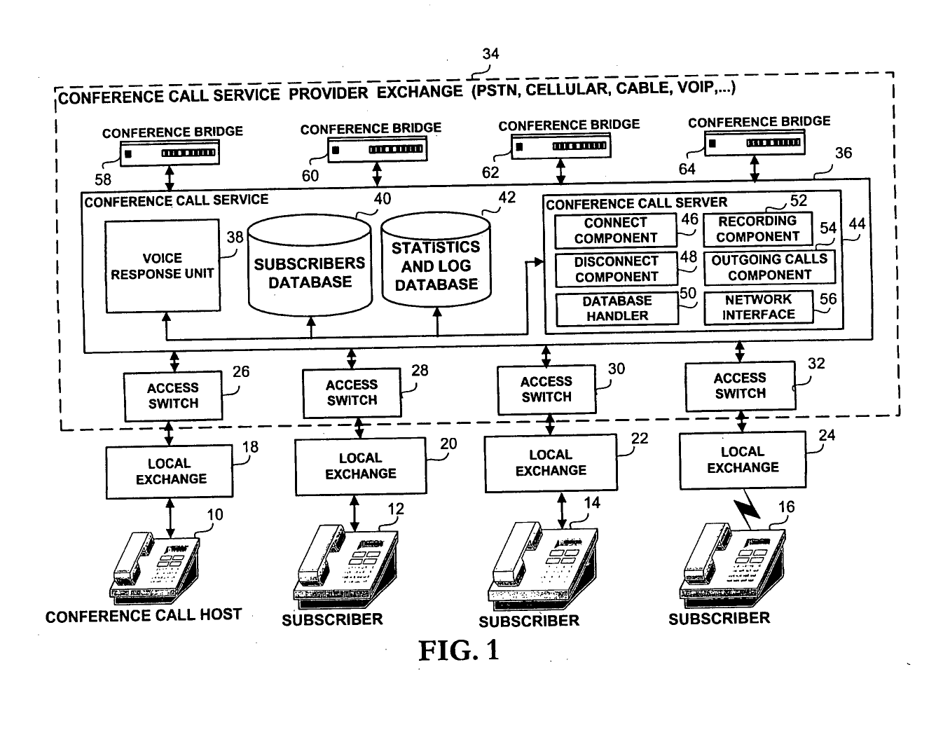

Reference is made now to FIG. 1 illustrating a simplified, exemplary telecommunications environment that could be used as a basic framework for the operation of a preferred embodiment of the proposed system and method of the present invention. Communication stations 10, 12, 14, and 16 are associated with various individual subscribers, such as organizations, business enterprises, offices, private persons, and the like. The stations 10, 12, 14, 16 are typically telephone devices, such as conventional telephone sets, cellular phones, private exchanges, personal computers with communications capabilities, satellite phones, two-way paging devices, PDAs, and the like. Each of the stations 10, 12, 14, 16 are having a particular telephone number via which connection can be made to the stations from other stations or from diverse network equipment. Consequent to the suitable dialing operation the stations 10, 12, 14, 16 are communicatively connected to telecommunications network exchanges associated with diverse telecommunications carriers. The station 10 shown in the figure under discussion is operated by a conference call host. A conference call host is a subscriber having a private conference call box, which is defined and set up in a telecommunication network. The conference call box provides the capability to the host to setting up or reserving a conference call for other subscribers to participate in. It would be easily understood that the other subscribers associated with the stations 12, 14, 16 could readily become conference call hosts by submitting suitable requests to the telecommunications network for the setting up of personal conference call boxes. The differences in the functionality, operations, available options, and responsibilities of a conference call host/subscriber and a regular subscriber will be described hereunder in association with the following drawings. The stations 10, 12, 14, 16 are connectable to one another or to a plurality of other stations (not shown) through appropriate dialing and switching procedures supported by the relevant exchanges. In the preferred embodiment of the invention the stations 10, 12, 14, 16 are linked to the local exchanges 18, 20, 22, 24 respectively. It would be easily understood that all the stations 10, 12, 14, 16 and a plurality of other stations (not shown) could be linked to a single local exchange or could be linked to additional local exchanges (not shown) associated with one or more telecommunications carriers. The local exchanges 18, 20, 22, 24 are linked communicatively to a conference call service provider network 34. The service provider network 34 could be an InterExchange (IXC), a Public Switched Telephone Network (PSTN), a cellular exchange, a cable telephony exchange, a network exchange (VoIP) or the like. Note should be taken that each of the local exchanges 18, 20, 22, and 24 could be conference call service provider networks. In this case the local exchanges will include the entire set of hardware and software devices functional to the operation of the service. In the preferred embodiment of the present invention the network 34 is a Public Switched Telephone Network (PSTN). The network 34 includes a conference call service 36 and several conference bridges 58, 60, 62, 64. The conference call service 36 is a logically related set of hardware devices and software components that are co-operatively functional in the provision of the conference call service feature by the network 34. The conference bridges 58, 60, 62, 64 are hardware devices having a variable number of communication ports to provide for the suitable bridging of several telephone calls so that simultaneous communication is accomplished between the bridged calls. The conference call service 36 includes a voice response unit (VRU) 38, a subscribers' database 40, a statistics and log database 42, and a conference call server 44. The VRU 38 is a set of integrated circuits specifically designed and manufactured for the enhancement of machine-human interaction with an Interactive Voice Response (IVR) feature. Several existing circuits could be utilized for that purpose, such as the MICRO-CALL type DSP-30 IC manufactured by Micro-Call (Israel) or the DIALOGIC type D/300 PCI E1/T1 IC manufactured by Dialogic.

Still referring to FIG. 1, the subscriber's database 40 is a data structure storing information in a machine-readable format. The database 40 is operative in holding subscriber related information, such as subscriber-specific conference call boxes, and the like. A more detailed description of the subscriber's database 40 will be set forth hereunder in association with the following drawings. The statistics and log database 42 is a data structure storing information in a machine-readable format. The database 42 holds historical data for the purposes of statistical analysis, operations follow-up, accounting purposes, market research, error-recovery, system maintenance, supplying answers to subscriber queries, and the like. The databases 40, 42 could be implemented on diverse standard storage devices, such as hard disks, magnetic disks, optical disks, RAM's, fast tape units, mass-storage systems, distributed storage systems, and the like. The databases 40, 42 could be located at diverse locations in the network 34, such as at Network Control Points (NCPs) (not shown) or Signal Transfer Points (STPs) (not shown) within the signaling sub-system (not shown) of the network 34. The databases 40, 42 are accessed, updated, and maintained by appropriate database processing interfaces such as the database handler component 50. The databases 40, 42 could be built and functioning via one of the known database organization methods such as hierarchical organization, relative organization, network format, and the like. In other preferred embodiments of the invention the databases 40, 42, could consist of separate tables and could be implemented on several separate hardware devices within or without the network 43. The conference call server 44 is a set of hardware devices and software programs functioning co-operatively for the handling of the conference call service feature, in accordance with the preferred embodiment of the present invention. Some of the components of the conference call server 44 are known, standard products while others are specifically developed for accomplishing the objectives of the system and method proposed by the present invention. The conference call server 44 includes a connection component 46, a disconnection component 48, a database handler 50, a recording component 54, an outgoing calls component 44, and a network interface 56. The connection component 46 is responsible for the connection and the associated of registration of the participants entering a conference call. The disconnection component 48 disconnects participants desiring to exit a conference call and suitably updates the list of current participants. The database handler component 50 accesses the appropriate databases 40, 42 for extracting information therein, for inserting data, for updating data, for deleting data, and the like. The recording component 52 is responsible for the recording of the calls within a conference call, for logging events, for collecting aggregate statistical data, errors, and the like. The outgoing calls component 54 is responsible for the launching of calls to a group of scheduled participants regarding their scheduled participation in the conference call. The component 54 further responsible for the launching of outgoing calls for participants during the conference call. The component 54 is supported by the MICRO-CALL type DSP-30 IC, or alternatively by the DIALOGIC D/300 PCI E1/T1 IC. The network interface 56 is responsible for transmitting suitable request to the network 34 in accordance with events taking place in association with the setting up, the establishment, and the performance of the conference call. The server 44 includes various specific integrated circuits operative in the functioning of the method and system co-operatively with the software components. Thus, the server 44 includes independent IVR hardware units (not shown) such as the TELEBASE type DSP-30 IC, the DIALOGIC type D/300 E1/T1, and the conference processor DCB/320 manufactured by the Intel Corp.

It would be easily perceived that the above-described components constituting the server 44 are exemplary only. A plurality of additional software components and associated hardware units can be used as an integral part of the server 44 in order to contribute to the optimal operation of the system and method. The server 44 could include a host handler to accept host registration, a conference call box handler, and the like. The server 44 could also include a statistical component supported by the DB FOX hardware of Microsoft or alternatively any other DB hardware.

The telecommunications environment described in association with FIG. 1 is highly simplified so as not to obscure the salient features of the present invention. For example in a realistic network the connections between the conference call service 36 and the conference bridges 58, 60, 62, 64 would be typically made through various access switching devices, or via switching devices. Furthermore, a practical telecommunications practical could include a plurality of conference bridges. The description is not meant to be limiting in any way to the various potential enhancements and improvements contemplated even now concerning the proposed system and method.

In order to register to the improved conference call service a subscriber has to contact a suitable telecommunications carrier that supports the requested service. Consequent to the registration the subscriber is assigned a telephone number or if applicable, the existing private telephone number of the subscriber could be used. The telephone number is logically linked by the service provider network to a subscriber-specific conference call box. The conference call box is unique to the subscriber and enables the subscriber to set up conference calls by entering conference-specific information into the box. In the text of this document a subscriber consequent to his/her registration to the improved conference call service will be referred to as the conference call host or the host. Note should be taken that the host could function as a regular subscriber by utilizing the communication station thereof in the standard manner, such as dialing to other subscribers in order to engage in a standard two-way voice call, to accept incoming voice calls, send voice mail, send text messages (if applicable) and generally to utilize his/her station in a completely standard manner. The conference call host could also participate in conference calls set up by other conference call hosts via their own specific conference call boxes, as a regular participant.

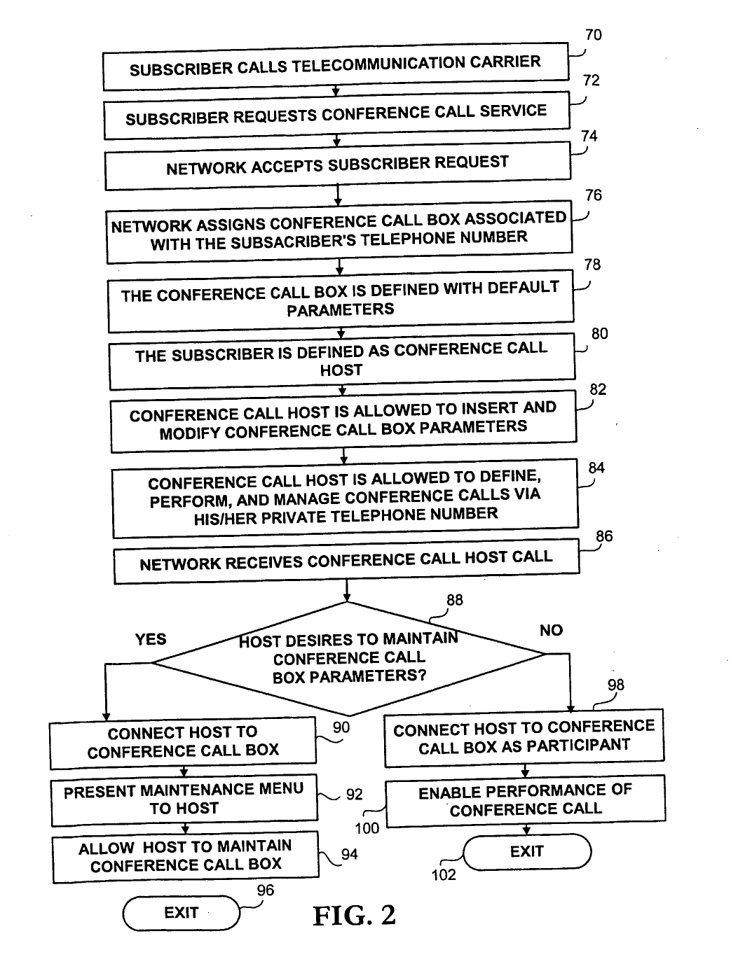

Reference is made now to FIG. 2 that illustrates the registration of a subscriber to the conference call service, the reservation of a conference call, and the entering of the host to the previously reserved conference call. The subscriber 10 of FIG. 1 desiring to join to the conference call service 36 of FIG. 1 dials a pre-defined number associated with the service 36. The dialing of the pre-defined number affects the setting up of a connection between the subscriber 10 and the suitable conference call support sub-system in the network (step 70). Consequently at step 72 the subscriber submits a request regarding registration to the conference call service. At step 74 the network 34 of FIG. 1 accepts the request from the subscriber 10 and performs a sequence of actions necessary for the registration of the subscriber to the service. Thus, at step 76 the network assigns a conference box to the telephone number of the subscriber. The conference call box is generated in the subscribers' database 40 of FIG. 1. The box is indexed for identification and access by the telephone number of the subscriber's station. In addition, the conference call box is filled with default parameters (step 78), such as a default conference call opening message, a default number of participants, and the like. A detailed description of the information held by the conference call box will be set forth hereunder in association with the following drawings. At step 80 the subscriber is considered by the network as a conference call host and as such he/she is allowed to insert and modify conference call-related parameters in the conference call box (step 82). From that point in time the conference call host is provided with the option of reserving a conference call, defining the useful parameters associated with the conference call box or with a particular conference call, such as the number the scheduled participants, the date and time of the scheduled conference, the list of telephone numbers to call automatically at the outset of the defined conference, and other operative information. The conference call host is allowed to define, to perform, and to manage conference calls via his/her communication station, which is identified by the network via its associated telephone number and via the logical association with his/her conference call box. At step 86 the network receives a call from the conference call host. At decision step 88 it is determined by the network whether the host wishes to perform maintenance of the conference call box parameters. If the result is positive at step 90 the network connects the host to the conference box thereof utilizing the originating number of the host's station as index and at step 92 the host is presented with a maintenance menu loaded from a pre-defined data structure in the network. In the preferred embodiment of the invention the interaction between the conference call host and the maintenance components of the conference call service is IVR-based. The service transmits voice messages to the host including explanations, help, and instructions. Thus, the host is guided by the voice messages through a sequence of operations functional to the maintenance of the information in the conference call box. The host is typically activates pre-defined keys installed on the keypad of the station thereof in order to generate DTMF tones. The DTMF tones are translated to signals, which are identified by the network and affect the execution of network-specific pre-defined commands. In other embodiments of the invention, the menu could be presented visually on a display screen of the station or could be communicated to the host in any other manner. Optionally the host could be prompted for keying in a specific authentication code sequence before being allowed to maintain the conference call box data. At step 94 the host completes the maintenance of the conference call box data and at step 96 exits the network by hanging up.

If at decision step 88 it is determined whether the host desires to enter a previously defined conference call then at step 98 the host identification such as the telephone number associated with the host's station is registered as a participant in the conference call and at step 100 the host's station is connected to the conference call via a pre-defined conference bridge. At the completion of the conference call or during the conference call the host could exit the conference call by hanging up (step 102). The conference call server updates the suitable list of participants and disconnects the host's station from the conference bridge. Note should be taken that after exiting the host could return to the continuing conference call at any point in time.

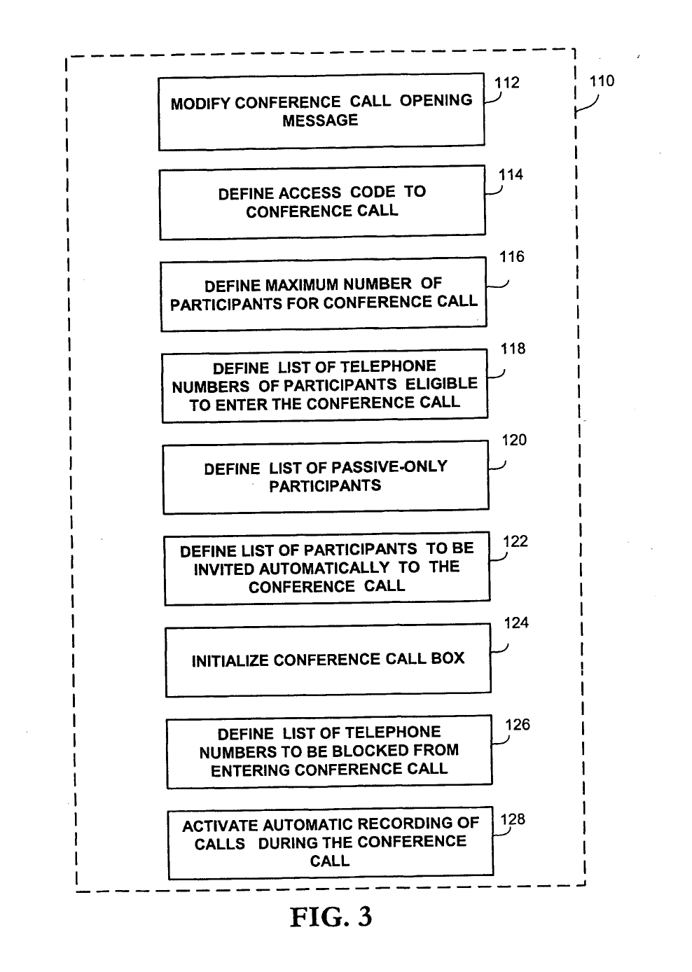

The menu presented by the conference call service to the conference call host is operative in providing the host the option of maintaining the functional information stored in the conference call box. Some of the information relates to characteristics of the conference call box while other data relates to a specific conference call. FIG. 3 illustrates an exemplary maintenance menu presented to the conference call host either as voice messages, text messages, graphical displays, or in any other suitable manner. The menu presents several exemplary menu items associated with specific options provided to the conference call host: 112) Modifying the conference call opening message. The conference call service could transmit a voice message to the host, such as “To modify the conference call opening message activate key 1”. If the host is desirous of recording a new opening message the push button “1” on the station's keypad is activated. The key generates a specific DTMF tone that is translated to a suitable signal and identified by the network. Consequent to the identification of the DTMF-based signal the network could initiate a series of operations such as instructing a database interface to allocate storage space on a memory device for a new opening message voice-formatted record, prepare and initialize a recording component and instruct the IVR component to transmit a voice message to the host consisting of the message “Please record the new opening message after the beep. At the end of the recording please push the # key”. The host could record the message and signal the completion of the recording according to the voice instruction. The network identifies the termination DTMF-based signal and performs a sequence of housekeeping operations, such as replacing the previous opening message with the new message, de-allocating working storage space, and the like. The foregoing description of the conference call box maintenance related interaction between the network and the conference call host is typical to the interactions taking place following the selection of the other options associated with the other menu items. Thus, if the host selects the “define access code” option 114, the network prompts the user for keying in an access code or to key in “000” for no access code. The network will recognize the responses of the host and if necessary will create a flag indicating the existence of an access code, and will store the access code (preferably strongly encoded) in a suitable record. In a similar manner the host could select option 116 in order to define the maximum number of participants in a conference call, option 118 in order to define and build a list of telephone numbers associated with scheduled participants that are eligible to enter the scheduled conference call, option 120 to define and build a list of telephone numbers associated with scheduled participants eligible to enter the conference call as “passive” participants or listeners only, option 122 to define and build a list of telephone numbers associated with scheduled participants to which calls should be launched before the start of the scheduled conference, option 124 to initialize the conference call box or to delete the entire set of records related to a specific conference call and thereby disconnecting all the participants, option 126 to define and build a list of telephone numbers associated with subscribers' stations that should be blocked from entering a scheduled conference, and option 128 to activate/deactivate automatic recording of calls during a conference call. For each of the above-described options associated with a specific menu item the host is prompted to key in specific code sequences to indicate to the network the type of option he/she wishes to select and to transmit to the network the specific input associated with the option.

It would be easily understood by one with ordinary skill in the art that the foregoing list of menu items and associated options is exemplary only. Diverse advanced options could be added such as creating a list of telephone numbers associated with scheduled participants that could be disconnected by the host during the performance of the conference call, the insertion of a mandatory conference call termination time, the enabling of a voice recognition device, the enabling of the exchange of private text messages between two or more participants, and the like.

The conference call is substantially controlled by the information stored in the conference call box. For example, to enter a conference call a scheduled eligible subscriber dials the telephone number associated with station of the host. The network receives the number and utilizing it as an index to determine the existence of an associated conference call box. If the conference call box is located then the conference call reservation is checked. According to the results of the data in the conference box the call of the subscriber is either rejected or processed appropriately, such as routing the subscriber's call to the pre-defined conference bridge. In addition, the conference call boxes are periodically scanned by the network to determine the starting times of the scheduled conferences. If a conference call box is found which defines a conference call scheduled to start after a pre-determined period of time then the network looks up the list of telephone numbers defined to be eligible to be notified in advance. Where such a list is found the network takes appropriate action by automatically launching suitable telephone calls based on the telephone numbers defined in the list.

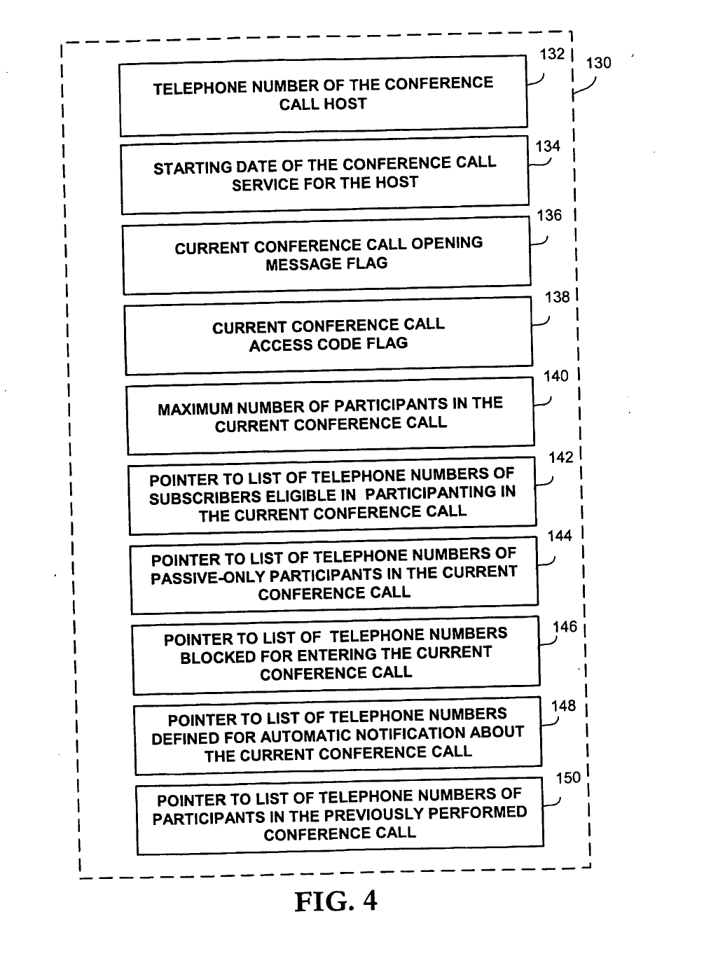

Reference is made now to FIG. 4 illustrating an interrelated set of exemplary data fields constituting the structure of an exemplary conference call box record 130. The record 130 includes the telephone number associated with the station of the conference call host 132, the starting date of the conference call service for the conference call host 134, a flag value indicating the availability of a conference call opening message 136, a flag value for indicating the availability of a conference call access code 138, a numerical value representing the maximum number of participants in the current conference call 140, a pointer value indicating the location of a list of telephone numbers associated with the stations of subscribers eligible in participating in the currently reserved conference call 142, a pointer value indicating the location of a list of telephone numbers associated with the stations of scheduled participants defined as “passive” only or “listeners” only 144, a pointer value indicating the location of a list of telephone numbers associated with the stations of subscribers blocked from entering the currently reserved conference call 146, a pointer value indicating the location of a list of telephone numbers associated with the stations of scheduled participants defined for the performance of automatic notification in regard to the outset of the currently reserved conference call 148, and a pointer value indicating the location of a list of telephone numbers associated with the stations of subscribers that participated in a previously performed conference call.

It would be easily understood that the conference call box could include additional fields, such as a flag value indicating the status of a conference. The value of “0” could indicate a “reserved” status, the “value of “1” could signify that the conference call is scheduled to begin after a pre-determined period, the “2” value could mean “conference call in-progress”, and the like. Additional useful fields could include “number of current participants”, a “host is participating” flag, timing values, such as “elapsed time”, “time left until scheduled termination”, and the like. Some of the fields could have values with specific meanings such as when the value of the maximum number of participants field 140 is set to “99” it could mean “no limitation on the number of participants”, and the like.

Note should be taken that the preferred embodiment of the present invention the conference call box is permanent and can store a number of scheduled conference calls indexed by the scheduled date and time of the conference. In other preferred embodiments the conference call box could be created dynamically whenever a host reserves a new conference call. In such a manner the box is initialized with data held as conference call host-specific information, which could be held in a specific hosts' table in the subscribers' database. The pointer values stored in the box point to location of tables formed in association with the subscriber database. Thus, such a list could include merely telephone numbers, which are utilized as pointers pointing at the more detailed subscriber records.

In the preferred embodiment of the present invention, the dialing of a communication station telephone number registered as a station whose subscriber is registered in the telecommunications carrier network as a conference call host will provide the caller with several options. Selecting one of the options will put the station in one of several modes of operation. Upon the reception of the call in the network the subscribers' database is scanned (or the suitable subscriber record is accessed directly) to obtain information about the called subscriber. In particular the record is examined for the value-added services associated with the called subscriber. If the subscriber is registered as a conference call host then the network interacts with the calling subscriber in order to allow the calling subscriber to select one out of several modes of operation. Thus, the caller could choose to engage in a standard voice conversation with the host, could choose to record a voice message intended to be stored in the voice message box of the called station (if the voice messaging feature is enabled) or could select to enter a conference call reserved by the host as a scheduled participant. Similarly a plurality of subscribers operating from diverse telecommunication carrier networks could dial the telephone number of the host, select the conference call participation mode, and enter the conference call as scheduled participants via the local exchange thereof, and via a particular access switch connecting the source communications network with the conference call service provider network. The entire set of calls dialed by the scheduled participants are processed by the conference call server and after being examined, verified, and authenticated, are routed via an access switch to a pre-defined port in a pre-defined conference bridge carrying the scheduled conference call.

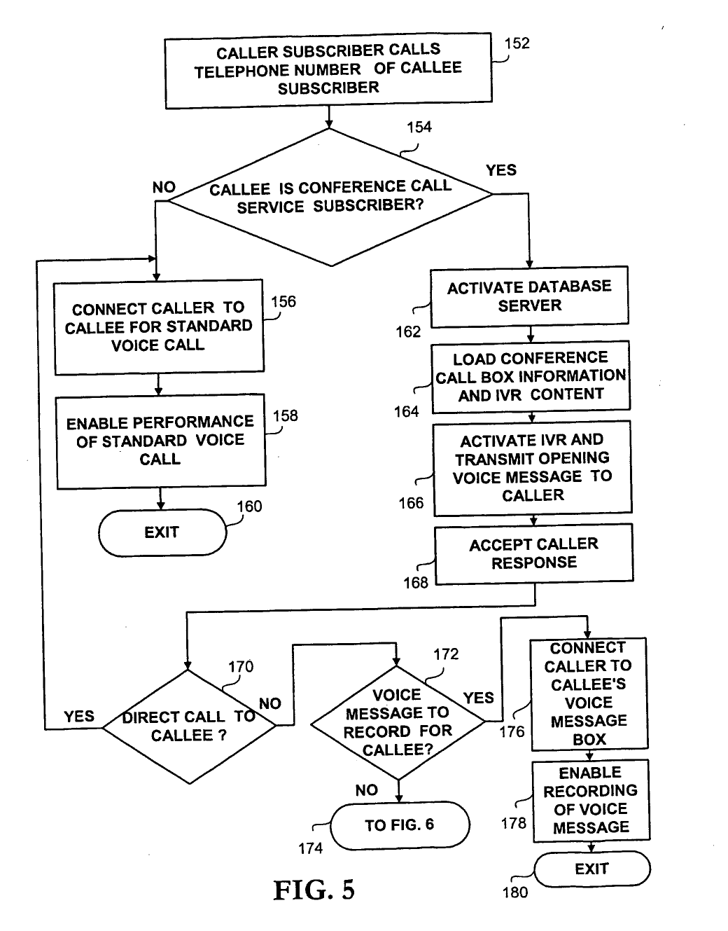

Referring now to FIG. 5 at step 152 a subscriber dials the telephone number of a called subscriber. The subscriber could be operating in the same telecommunications network or could be located in a different network. For example, the calling subscriber could call dial from a cellular network while the called subscriber could be PSTN-based. At step 154 the receiving network examines the record the called subscriber to determine if the called subscriber is a conference call host. The examination is performed by accessing the subscriber record in the subscriber database, to extract the record, and to examine suitably the appropriate indicator fields. If the result of the examination is negative then the network connects the caller to the station of the called subscriber for the performance of a standard voice call (step 156). At step 158 the voice call is enabled and at the termination of the voice call the connection is torn down (step 160). The voice messaging service is activated optionally if the called subscriber is unable or unwilling to accept to call in order to allow the caller to leave a message recorded and stored in the called subscriber's voice messaging box. If at decision step 154 it is determined that the called subscriber is a conference call host then at step 162 the database handler is activated, at step 164 the information stored of the host-specific conference call box, and the voice records associated with the VRU component are loaded into the processor at step 164. Consequently at step 166 the VRU is activated and transmits an opening voice message to the caller including several menu items and a prompt requesting the caller to select one out of several options associated with the menu items provided. In the preferred embodiment of the invention, the voice message includes the following:

“In order to enter a conference call reserved by the called subscriber use the “1” key”

“In order to place a personal voice call to the called subscriber use the “2” key”

“In order to leave a voice message to the called subscriber use the “3” key.”

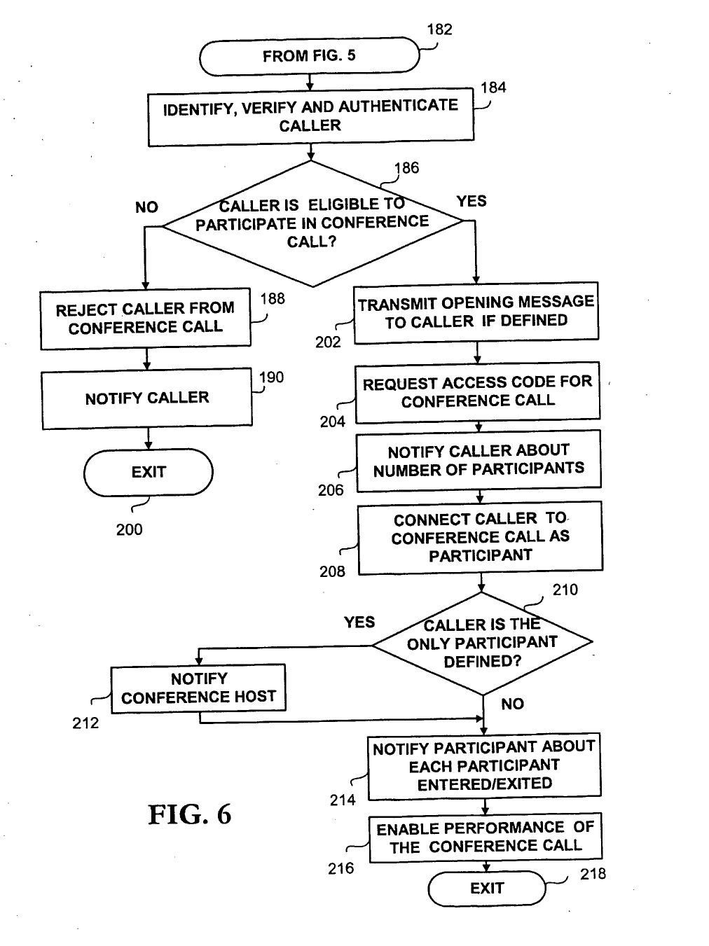

The responses of the caller are pre-defined by the server and limited to the suitable activation of the above-mentioned keys. Mistaken responses made by the caller will affect repeated replay of the voice message in order to notify the caller of the erroneous actions. Activating one of the pre-defined keys will affect the generation of a suitable DTMF signal comprising a pair of specified frequencies, which is transmitted to the conference call service provider network. At step 168 the server accepts the response of the caller, and identifies the response according to the frequencies of received signal. At decision step 170 it is determined whether the caller activated the “2” key in order to initiate a private voice conversation with the called subscriber. If the result of the decision step 170 is positive then the program control proceeds to step 156 to connect the caller and the called subscriber for a standard personal call. Subsequently at step 158 the private voice conversation is enabled and at step 160 the call is terminated. The connection is torn down and the server program returns control to the network. If at step 170 it is determined that the caller does not wish to engage in a two-way private voice conversation with the called subscriber then at decision box 172 it is determined whether the caller desires to leave a voice message for the called subscriber. If the resulting value of the decision step 172 is positive then at step 176 the caller's station is linked to the called subscriber's voice message box, at step 178 the enabling of a voice message recording is affected. At the termination of the recording the connection is torn down (step 180) and the server returns control to the network. If the resulting value of the decision step 172 is negative then the server program control proceeds to step 182 of FIG. 6 in order to process regarding a request to enter a scheduled conference call.

Referring now to FIG. 6, which is a continuation flow chart of FIG. 5. The flow chart illustrates the sequence of the operational steps functional in the processing of a call dialed by a subscriber desiring to enter a scheduled conference call. At step 184 the conference call service identifies the caller subscriber where the identification is made on basis of the call-originating telephone number associated with the communication station of the caller. The subscriber-specific information is obtained from the subscriber database and the service verifies, and authenticates the right of the subscriber to participate in the scheduled conference call by scanning the suitable list of telephone numbers pointed at by the appropriate pointer value in the conference call box associated with the telephone number dialed by the subscriber. Optionally the identity of the subscriber is authenticated by being requested to enter an access code associated with the scheduled conference call. Thus, at decision step 186 it is determined whether the subscriber is eligible to participate in the requested conference call where the process of determination is based on the originating telephone number of the subscriber, the called telephone number associated with a conference call box, the conference-related information stored in the conference box, the subscriber-specific information in the subscriber database, and the like. In other preferred embodiments of the invention, more advanced methods could be used to identify a potential participant in a scheduled conference call, such as voice recognition sub-systems, and the like. When it is determined at decision step 186 that the caller is not eligible to participate at step 188 the subscriber is rejected by the service, at step 190 the subscriber is notified accordingly, and at step 200 the connection between the station of the subscriber and the conference call provider network is torn down. Consequently, the conference call server returns control to the network control program.

Still referring to FIG. 6 is the result of the process performed by the decision step 186 is positive then the server recognizes the eligibility of the subscriber to enter the requested conference call. At step 204 the UVR component of the server transmits a conference opening voice message to the subscriber. The message could include a welcoming segment, a brief description of the conference call, a set of necessary rules regarding conference-call etiquette, one or more useful operating instructions, and the like. For example, the opening voice message could include sentences operative in assisting the subscriber in the actions to be taken for the accomplishment of specific options, such as “To exit the conference call use the # key”, and the like. If the conference call opening message was not customized by the conference call host then a standard, custom message will be transmitted to the subscriber such as “You are now joining a conference call No. XXXX, reserved from telephone number XX-XXX-XXXX. The number of currently logged in participants is five including the conference host. The conference is scheduled to start in 45 seconds . . . ”, and the like (step 206). At step 208 the subscriber is linked to the conference call by the server. The connection is accomplished by the connection of the subscriber's communication station via suitable switching procedures to a pre-defined communication port in a pre-defined conference bridge carrying the conference call.

If the scheduled starting time of the conference is reached and the conference call host still not entered the conference the server could automatically launch a call to conference call host in order to transmit a voice message including a reminder (step 212). If a subscriber enters a conference in advance of all the other scheduled participants the server transmits a voice message to inform the subscriber that currently he/she is the only participant in the conference call and to advise the subscriber to wait until the other participants join in (step 210, 214). A subscriber desiring to enter a conference could do it by dialing a specific short sequence of digits. In addition to his/her own communication station the subscriber could also join a conference from any other communication station operating in the same network or from any other network. The connection to the conference call is achieved by the dialing of the telephone number of the original communication station. At step 216 the conference call is performed. The subscriber could exit the conference call in any point of time to perform necessary actions, such as answering an urgent call not connected to the conference. Subsequent to the performance of the required external action the subscriber could return and join the conference call. If the recording option was activated then optionally the subscriber could replay the suitable segments of the recording in order to get updated on the proceedings that took place in the course of the conference during the absence of the subscriber.

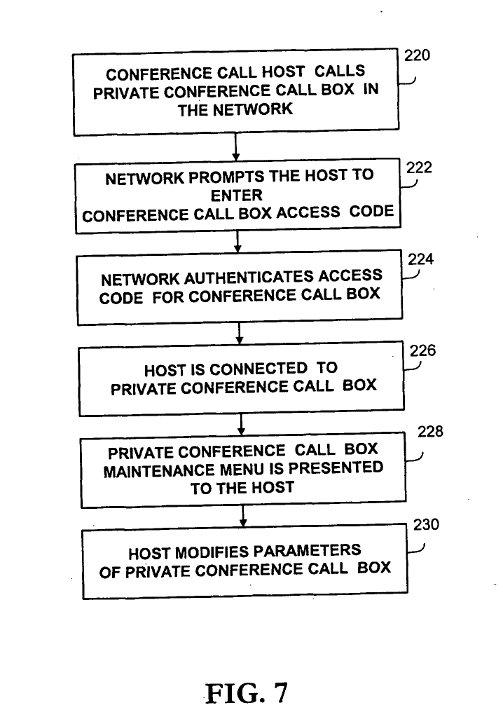

FIG. 7 illustrates the procedure involved in the maintenance of the conference call box data by the conference call host. At step 220 the conference call host calls his/her private conference call box in the network. The connection could be affected by the host dialing his/her own number or by the dialing of a specific short sequence of digits. At step 222 the network prompts the host to enter a unique access code. At step 224 the network authenticates the access code and at step 226 the host is connected to the private conference call box. In the preferred embodiment of the invention, the routing is accomplished by the “follow-me” routing feature typically implemented in the majority of telecommunications networks. In other preferred embodiments other routing methods could be used. At step 228 the conference call box maintenance menu is presented to the host either through the VRU interface or via a text based of graphical display on the suitable display screen associated with the host's station. The menu includes a set of sub-menu items associated with maintenance options provided to the conference call host. Following the real-time instructions of the network the host is provided with the capability of inserting useful control information into the conference call box, such as reserving conference calls for a specific date and time, modifying existing information, set parameter values, such as the number of participants building control lists, such as the list of subscribers blocked from entering the conference, record voice messages, such as the conference call opening message, determine operational procedures, such as the automatic opening of a conference call, customizing conference processes, such as dialing a voice message notifying the participants regarding the entry of a new participant, and the like.

It would be easily perceived by one with ordinary sill in the art that the list of modifiable, customizable, updateable parameters, options, lists, messages, procedures described hereinabove is exemplary only. Additional useful parameters could be added, such as enabling or disabling of an option for the performance of a private sub-conference between two or more of the participants within the framework of the main conference call, and the like.

If the system and method of the present invention is adopted then each and every specific communication station connected to a communications network, such as a traditional telephone set, a cellular device, a PDA, a satellite phone, a two-way radio, a pager, a personal computer, or the like, would be provided with the option of being transformed into a personal conference call line. As a result the subscriber associated with the communication stations is provided with conference call host capabilities. Consequently the operational procedures concerning a conference call associated with the personal conference call line will be substantially improved in regard to the prior art. The improvements regard practically all the stages of the procedure, such as the definition of a conference call, the reservation of a conference call, the notification of the scheduled participants in regard to the conference call, the routing of the participants to the conference call, and the smooth performance of the conference call.

It will be appreciated by persons skilled in the art that the present invention is not limited to what has been particularly shown and described hereinabove. Rather the scope of the present invention is defined only by the claims, which follow.

1. An electronic conference call system comprising the elements of:
a plurality of communication stations, operated by a plurality of subscribers, for participating in at least one conference call provided by a conference call service in such a manner that each of the plurality of communication stations is able to communicate with a the plurality of communication stations participating in at least one conference call;
at least one communication station having the functionality of conference call line operated by at least one subscriber having the capability of a conference call host in order to enable the setting up, establishment, performance, and management of at least one conference call associated with the at least one communication station to enable participation of a plurality of conference call service subscribers in the at least one conference call;
at least one communication network having network equipment for interconnecting the plurality of communication stations, to a conference call service;
a conference call service comprising the elements of;
a subscriber database to store the operational information related to at least one conference call, the functional definition of a plurality of communication stations serving a plurality of conference call service subscribers, and the functional definitions of the at least one communication station with the functionality of the conference call line operated by the at least one conference call host;
a conference call server for the providing at least one communication station with conference call line functionality and providing at least one subscriber of at the least one communication station with conference call host capability, to enable the setting up, establishment, management, and performance of the conference call, the conference call server comprising the elements of:
a database component to handle subscriber information, conference host information, communication stations information, and conference call information;
a connection component to connect at least one subscriber desirous of participating in a conference call to the conference call line;
a disconnection component to disconnect at least one subscriber desirous of withdrawing from the conference call from the conference call line; and
a network interface component to enable proper communication between the conference call service and the communications network;
wherein when a communication station requests the functionality of conference call line the conference call service provides conference call line status to the requesting station, when the station with conference call line status issues requests for the setting up, establishment and management of a conference call the conference call service responds to the requests, when requests are introduced from a plurality of a communication stations to participate in the established conference call, the conference call service connect the stations to the conference call line;
whereby each and every communication station connected to the communications network is enabled to operate optionally as a conference call line, and the subscribers associated with the communication stations are allowed to operate as conference call hosts.

2. The system according to claim 1 wherein the conference call service further comprises the elements of:
a statistics and log database to store a plurality of indication record concerning activity of the at least one communication network; and
a voice response unit to enable voice communications between the conference call service and the at least one conference call host and the plurality of the conference call service subscribers.

3. The system of claim 1 wherein the conference call server further comprises the elements of:
a recording component to provide call-recording capabilities; and
an outgoing call component to provide automatic call launching capabilities from the conference call server.

4. The system of claim 1 wherein the communications network further comprises the elements of:
a plurality of switches to connect between the various components of the system;
at least one conference bridge having at least two communication ports to combine a plurality of calls in the framework of a conference call.

5. The system of claim 1 wherein the subscriber database includes at least one conference box data structure logically associated with at least one conference call line, and operative in the management of at least one conference call, comprising the elements of:
an identification of the conference call line;
a starting date of the conference call service for the conference call line;
an indicator concerning the number of participants in the conference call;
a set of data structure address values pointing at suitable data structures comprising:
a list of communication station associated subscribers eligible of participating in the conference call;
a list of communication stations associated subscribers blocked from participating in a conference call; and
a list of communication stations associated subscribers defined as eligible for a conference call participation-specific notification.

6. An electronic conference call method comprising the steps of:
accepting the request of a subscriber associated with a communication station concerning the setting up of the communication station of as a conference call line;
assigning a conference call-specific data structure to the requesting communication station and establishing the conference call-specific data structure;
maintaining conference call-specific parameters in the conference call data in accordance with the requests introduced by the subscriber of the communication station associated with the conference call data structure;
receiving requests of a plurality of subscribers associated with a plurality of communication stations concerning the participation thereof in the conference call associated with a conference call data structure;
connecting to the conference call line subscribers participating in a conference call associated with a conference call data structure; and
disconnecting from the conference line subscribers desirous of withdrawing from a conference call associated with a conference call data structure.

7. The method of claim 6 of accepting further comprises the sub-steps of:
identifying the communication station and the subscriber operating the communication station; and
examine, validate and authorize the establishment of the communication station as a conference call line.

8. The method of claim 6 of wherein the modifying the parameters comprises the sub-steps of:
modifying conference call opening message;
defining a specific access code for the conference call;
defining the maximum number of participants for the conference call;
building a list of communication stations associated with subscribers eligible to participate in the conference call;
generating a list of communication stations associated with subscribers eligible to participate in the conference call as passive participants only;
creating a list of communication stations associated with subscribers eligible to automatic notification concerning participation in the conference call;
generating a list of communication stations associated with subscribers not eligible to participate in the conference call;
activating automatic recording of calls during a conference call.

9. The method of claim 6 wherein the step of receiving further comprises the sub-steps of:
examining the access rights of the communication station to the conference call system;
verifying the identity of the communication station;
activating the conference call data structure handler in order to enable reading of control information from the data structure;
obtaining conference call data information from the conference call data structure;
activating Interactive Voice Response to allow for voice communication between the conference call server and the communication station;
transmitting opening voice message to the communication station;
accepting response from the communication station;
connecting the communication station to the conference call data structure.

10. The method of claim 9 further comprises the sub-steps of:
requesting access code for the conference call;
notifying the communication station concerning the number of current participants;
notifying the conference call host concerning the connection of the communication station;
notifying each participant concerning the connection of the communication station.

11. The method of claim 6 further comprises the steps of:
interrogating the communication station regarding the objectives of the call;
accepting the response of the communication station;
according to the response of the communication station perform suitable switching across the network to enable standard voice call to the communication station dialed to;
according to the response of the communication station enabling the activation of a voice-message sub-system; and
according to the response of the communication station connecting the communication station to the conference call line.

12. The system of claim 1 wherein the communications network is a Public Switched Telephone System.

13. The system of claim 1 wherein the communications network is a cellular communications network.

14. The system of claim 1 wherein the communications network is a data communication network.

15. The system of claim 1 wherein the communication station is a telephone device.

16. The system of claim 1 wherein the communication station is a cellular phone device.

17. The system of claim 1 wherein the communication station is a personal computer.
